(19) United States
(12) Patent Application Publication
(10) Pub. No.: US 2021/0043195 A1
(43) Pub. Date: Feb. 11, 2021

(54) AUTOMATED SPEECH RECOGNITION SYSTEM

(71) Applicant: Cerence Operating Company, Burlington, MA (US)

(72) Inventors: Stefan Christof HAHN, Cologne (DE); Efthymia GEORGALA, Chexbres (CH); Olivier Stéphane Jérôme DIVAY, VIEUX-VY SUR COUESNON (FR); Eric Joseph MARSHALL, Bellevue, WA (US)

(73) Assignee: Cerence Operating Company, Burlington, MA (US)

(21) Appl. No.: 16/532,751

(22) Filed: Aug. 6, 2019

(51) Int. Cl. G10L 15/183; G06F 17/27

(52) U.S. Cl. CPC G10L 15/183; G10L 2015/025; G06F 17/278

(57) ABSTRACT

There is provided an automated speech recognition system that applies weights to grapheme-to-phoneme models, and interpolates pronunciations from combinations of the models, to recognize utterances of foreign named entities for naive, informed, and in-between pronunciations.

### BACKGROUND OF THE DISCLOSURE

### 1. Field of the Disclosure

The present disclosure relates to automatic speech recognition (ASR), and more particularly, to an ASR system that strives for accuracy of foreign named entities via speaker respectively speaking-style dedicated modeling of pronunciations. A foreign named entity in this context is defined as a named entity that consists of one or more non-native words. Examples of foreign named entities are the French street name “Rue des Jardins” for a native German speaker, or the English movie title “Anger Management” for a native Spanish speaker.

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

In some products that employ automated speech recognition, a user may wish to pronounce a foreign named entity. For example, a German user may wish to drive to a destination in France, or request to view an English TV show. The pronunciation of the foreign named entity is highly speaker-dependent and depends on his/her knowledge of the foreign language. They may be a naive speaker, having little or no knowledge of the foreign language, or an informed speaker who is a fluent speaker of the foreign language. Moreover, some pronunciations used for foreign named entities are in-between these two extremes and very frequently lead to misrecognitions.

### SUMMARY OF THE DISCLOSURE

There is provided an ASR system that applies weights to grapheme-to-phoneme models, and interpolates pronunciations from combinations of the models, to recognize utterances containing foreign named entities for naive, informed, and in-between pronunciations.

### BRIEF DESCRIPTION OF THE DRAWINGS

FIG. 1 is a block diagram of an ASR system.

FIG. 2 is a block diagram of an ASR engine and its major components.

FIG. 3 is a block diagram of a workflow to obtain pronunciation dictionaries that are typically used in an ASR system to recognize speech.

FIG. 4 is a block diagram of a process to generate pronunciations for one or several tokens, where a token is defined as one or more words representing a unit that may be output by an ASR system.

A component or a feature that is common to more than one drawing is indicated with the same reference number in each of the drawings.

### DESCRIPTION OF THE DISCLOSURE

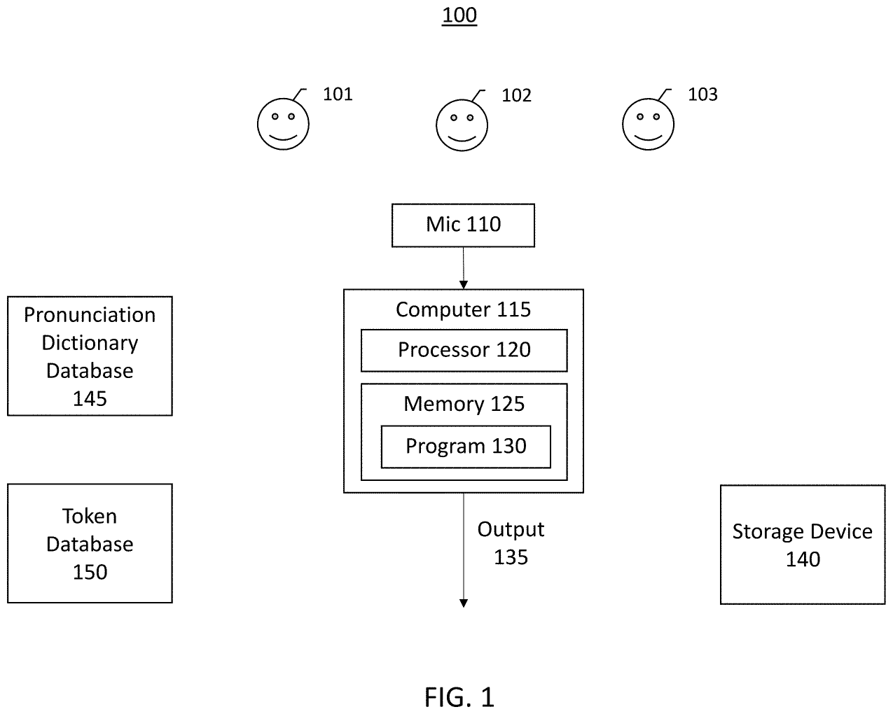

FIG. 1 is a block diagram of an ASR system, namely system 100. System 100 includes a microphone (Mic) 110 and a computer 115. Computer 115, in turn, includes a processor 120 and a memory 125. System 100 is utilized by users 101, 102 and 103.

Microphone 110 is a detector of audio signals, e.g., speech from users 101, 102 and 103. Microphone 110 outputs detected audio signals in the form of electrical signals to computer 115.

Processor 120 is an electronic device configured of logic circuitry that responds to and executes instructions.

Memory 125 is a tangible, non-transitory, computer-readable storage device encoded with a computer program. In this regard, memory 125 stores data and instructions, i.e., program code, that are readable and executable by processor 120 for controlling operation of processor 120. Memory 125 may be implemented in a random access memory (RAM), a hard drive, a read only memory (ROM), or a combination thereof. One of the components of memory 125 is a program module 130.

Program module 130 contains instructions for controlling processor 120 to execute methods described herein. For example, under control of program module 130, processor 120 will receive and analyze audio signals from microphone 110, and in particular speech from users 101, 102 and 103, and produce an output 135. For example, in a case where system 100 is employed in an automobile (not shown), output 135 could be a signal that controls an air conditioner or navigation device in the automobile.

The term “module” is used herein to denote a functional operation that may be embodied either as a stand-alone component or as an integrated configuration of a plurality of subordinate components. Thus, program module 130 may be implemented as a single module or as a plurality of modules that operate in cooperation with one another. Whereas program module 130 is a component of memory 125, all of its subordinate modules and data structures are stored in memory 125. However, although program module 130 is described herein as being installed in memory 125, and therefore being implemented in software, it could be implemented in any of hardware (e.g., electronic circuitry), firmware, software, or a combination thereof

While program module 130 is indicated as being already loaded into memory 125, it may be configured on a storage device 140 for subsequent loading into memory 125. Storage device 140 is a tangible, non-transitory, computer-readable storage device that stores program module 130 thereon. Examples of storage device 140 include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random access memory, and (i) an electronic storage device coupled to computer 115 via data communications network (not shown).

A Pronunciation Dictionary Database 145 contains a plurality of tokens and their respective pronunciations (prons) in a multitude of languages. These may also include token/pron pairs of, for example, native and foreign named entities, or in general any token/pron pair. A token may have one or more different pronunciations. Pronunciation Dictionary Database 145 might also contain a pronunciation dictionary of a given language and might have been manually devised or be part of an acquired data base, or might be a combination thereof. Pronunciation Dictionary Database 145 might also contain additional meta data per token/pron pair indicating for example the language of origin of a specific token. This database might be used within Program 130 to generate one or more naive, informed, or in-between pronunciations for foreign named entities, which are provided in a Token Database 150. For example, Token Database 150 might contain French, Spanish, and Italian street names. Token Database 150 might additionally contain meta data per token indicating for example the language of origin of a specific token. Both, Pronunciation Dictionary Database 145 and Token Database 150 are couple to computer 115 via a data communication network (not shown).

In practice, computer 115 and processor 120 will operate on digital signals. As such, if the signals that computer 115 receives from microphone 110 are analog signals, computer 115 will include an analog-to-digital converter (not shown) to convert the analog signals to digital signals.

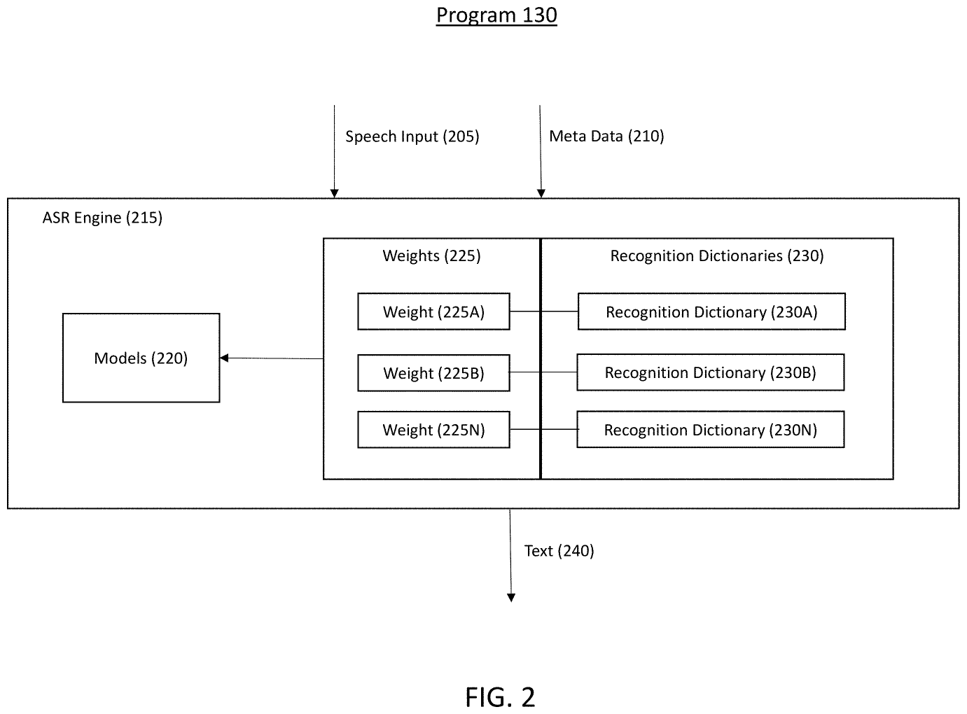

FIG. 2 is a block diagram of program module 130, depicting an ASR engine 215, its major components, namely Models 220, Weights 225, and Recognition Dictionaries 230. ASR Engine 215 has inputs designated as Speech Input 205 and Meta Data 210, and an output designated as Text 240.

Speech Input 205 is a digital representation of an audio signal detected by Microphone 110, and may contain speech, e.g., an utterance, from one or more users 101, 102, and 103, and more precisely, it may contain named entities in more than one language, e.g., one or more foreign words or phrases in a native language speech input. Meta Data 210 may contain additional information related to Speech Input 205 and may contain, for example, geographic coordinates from a Global Positioning System (GPS) of an automobile or a hand-held device that users 101, 102, and 103 may use at this time, or any other information associated with Speech Input 205 deemed relevant for a specific use case.

ASR Engine 215 may be comprised of several modules, which are interconnected to convert Speech Input 205 into a written, textual representation of the uttered content of Text 240. To do so, statistical or rule-based Models 220 may be used. Models 220 may rely on one or more Recognition Dictionaries 230 to define the words or tokens which can be output by the system. Three such Recognition Dictionaries 230 are shown, namely Recognition Dictionaries 230A, 230B and 230N. A token is defined as one or more words representing a unit which may be recognized by system 100. For example, “New York” may be considered as one multi-word token. A recognition dictionary may store a plurality of tokens, possibly including named entities, and one or several pronunciations for each of these tokens. A pronunciation may consist of one or several phonemes, where a phoneme represents the smallest distinctive unit of a spoken language. Further, different Recognition Dictionaries 230 may contain the same tokens but with different pronunciations. Using Weights 225A, 225B and 225N, collectively referred to as Weights 225, one or more of the Recognition Dictionaries 230 may be activated during recognition of Speech Input 205, whereas Weights 225 may depend on Meta Data 210. For example, Recognition Dictionary 230A may contain a naive pronunciation for a token representing a foreign named entity, whereas Recognition Dictionary 230B may contain a different, informed pronunciation for the same foreign named entity. Meta Data 210 may now indicate that User 101 is in a country where the target foreign language is spoken according to, for example, GPS coordinates, i.e., a location, of User 101 or of a device being used by User 101. Thus, Weights 225 may be set in a way that the respective Recognition Dictionary 230B is considered by ASR engine 215, thus making it possible to recognize the informed pronunciation of the foreign named entity.

Text 240 represents the output of ASR Engine 215, which may be a textual representation of Speech Input 205, which in turn may, for example, be simply displayed to the user, or which may, for example, be a signal used to control a user device, such as, for example, a navigational device in an automobile, or a remote control for a television.

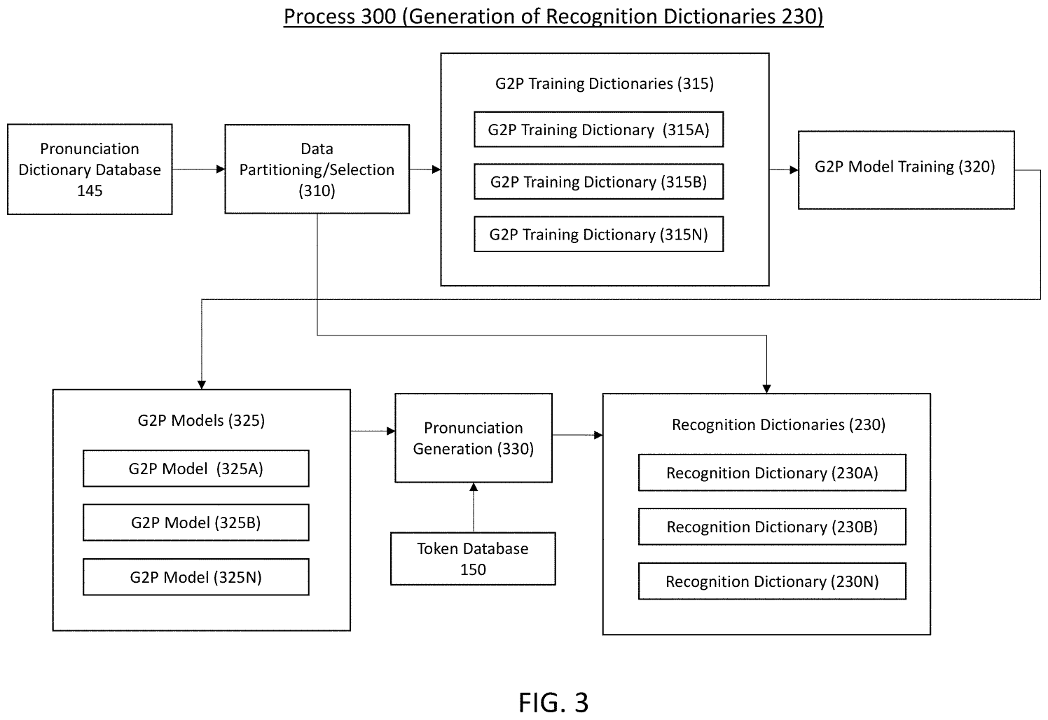

FIG. 3 is a block diagram of a process, namely Process 300, to generate Recognition Dictionaries 230. Process 300, which might be a part of Program 130, uses Pronunciation Dictionary Database 145 and Token Database 150 as inputs, and outputs Recognition Dictionaries 230. Note that Process 300 might need to be executed prior to execution of some other processes of Program 130.

Pronunciation Dictionary Database 145 contains a plurality of tokens in a given language along with their respective pronunciations (prons). Data Partitioning/Selection 310 clusters these pairs into groups resulting in one or more Grapheme-to-Phoneme (G2P) Training Dictionaries 315, three of which are shown and designated as G2P Training Dictionaries 315A, 315B and 315N. Using G2P Training Dictionaries 315, a G2P Model Training 320 module generates one or several G2P Models 325A, 325B and 325N, which are collectively referred to as G2P Models 325, and which are utilized within a Pronunciation Generation 330 module to generate pronunciations for input tokens from Token Database 150.

Data Partitioning/Selection 310 is a module for partitioning token/pron pairs from Pronunciation Dictionary Database 145 into one or more clusters that may or may not overlap. For example, one of these clusters could contain all token/pron pairs where the tokens are identified as being of French origin, whereas another cluster could contain all token/pron pairs where the tokens are identified as being of English origin. Another example would be to cluster the token/pron pairs according to dialect or accent. For example, one of the clusters might contain Australian English token/pron pairs, whereas another cluster might contain British English token/pron pairs. The origin of a token might be identified via available meta data, such as, a manually assigned tag/attribute, or, for example, a possibly automatic language-identification method, or any other method. The clusters of token/pron pairs constitute the G2P Training Dictionaries 315. Additionally, Data Partitioning/Selection 310 might be used to select certain token/pron pairs to be directly used within any of Recognition Dictionaries 230. For example, Data Partitioning/Selection 310 might select all token/pron pairs where the token is of English origin and might add those to Recognition Dictionary 230A.

G2P Training Dictionaries 315 constitute one or more dictionaries containing token/pron pairs that are used to train one or more G2P models in G2P Model Training 320.

G2P Model Training 320 utilizes one or more dictionaries of token/pron pairs to train a grapheme-to-phoneme converter model, for which one or more statistical or rule-based approaches, or any combination thereof, may be used. The output of G2P Model Training 320 is one or more G2P models 325.

G2P Models 325 consists of one or more G2P models, which are used to generate one or more pronunciations for input tokens from Token Database 150. These models may have been built to, for example, represent different languages, accents, dialects, or speaking styles.

Pronunciation Generation 330 generates one or more pronunciations for each token from Token Database 150. The generated pronunciations may capture different speaking styles, for example naive, informed, or in-between pronunciations of foreign named entities. The generated token/pron pairs are used to generate or augment Recognition Dictionaries 230.

Token Database 150 might contain tokens for each of which we might want to derive one or several pronunciations. For example, Token Database 150 might contain foreign named entities in several languages. For each of these tokens we might want to generate a naive, an informed, and an in-between pronunciation. Token Database 150 might for example be manually devised based on a given use case, e.g., we might want to generate pronunciations for all French, Spanish, and Italian city names to be used to control a German navigational device in an automobile.

Recognition Dictionaries 230 are constructed by combining token/pron pairs from Pronunciation Dictionary Database 145 with token/pronunciation pairs output from Pronunciation Generation 330. For example, Pronunciation Dictionary Database 145 might contain a plurality of token/pron pairs for regular German tokens, which are carried over to Pronunciation Dictionary 230A, thus representing the majority of German words and their typical pronunciations. Pronunciation Dictionary Database 145 might also contain a plurality of token/pron pairs representing informed pronunciations for French named entities. These token/pron pairs might be incorporated into Pronunciation Dictionary 230B, thus containing foreign French named entities. We might have French tokens in Token Database 150, for which we do not have any pronunciations in Pronunciation Dictionary Database 145, and we want to generate pronunciations utilizing Pronunciation Generation 330, resulting in additional token/pron pairs, possibly representing naive, informed, and in-between pronunciations for the French tokens. These token/pron pairs might be used to augment Pronunciation Dictionaries 230B.

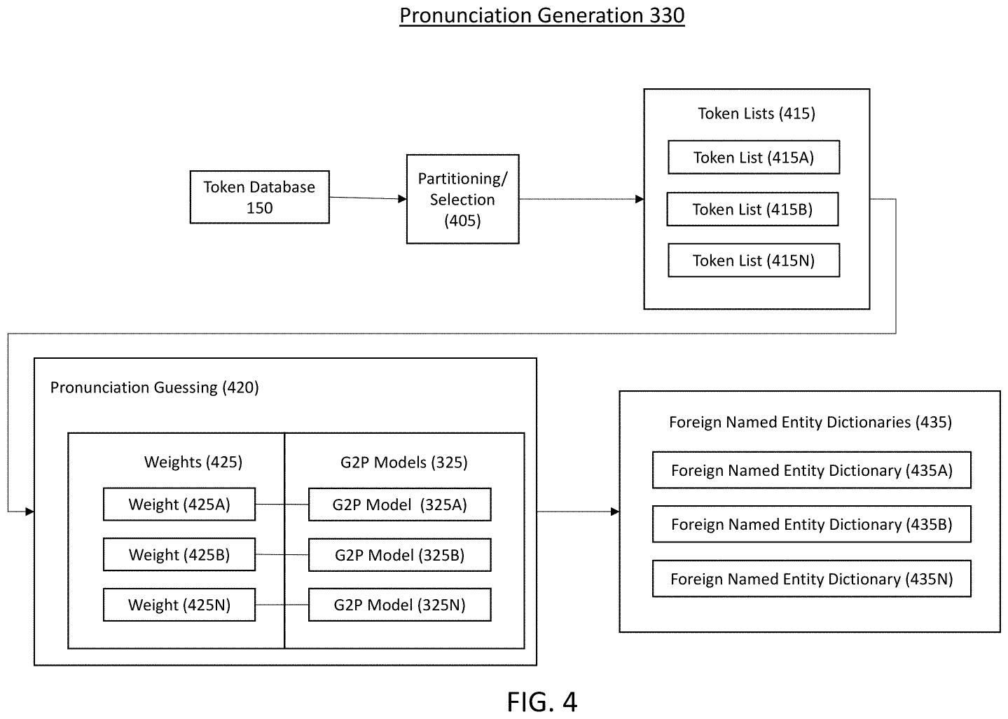

FIG. 4 is a block diagram of Pronunciation Generation 330. Pronunciation Generation 330 generates pronunciations for tokens from Token Database 150, utilizing G2P Models 325, resulting in Foreign Named Entity Dictionaries 435, three of which are shown and designated as Foreign Named Entity Dictionaries 435A, 435B and 435N, which in turn might be used to generate or augment Recognition Dictionaries 230.

Partitioning/Selection 405 partitions tokens from Token Database 150 into several possibly overlapping clusters, whereas the criteria on how to partition the tokens may be derived by using meta data which also might come with Token Database 150. The output of Partitioning/Selection 405 is one or several Token Lists 415, three of which are shown and designated as Token Lists 415A, 415B and 415N. For example, meta data may indicate that one or several tokens from Token Database 150 are of French origin, which may be used by the module Partitioning/Selection 405 to cluster those tokens into one group, resulting in Token List 415A containing all tokens from Token Lists 415 of French origin. The meta data per token might be incorporated into Token Lists 415. The origin of a token may, for example, also be identified via a possibly automatic language identification method, or any other method.

Meta data might be part of Token Database 350. For example, Token Database 350 might contain a list of cities, whereas accompanying meta data might contain accompanying GPS coordinates for the cities, and might thus be used within Partitioning/Selection 405, besides other data, to partition these cities according to country of origin.

Token Lists 415 is comprised of one or more lists of tokens. For example, Token List 415A may consist of tokens of German origin, while Token List 415B may consist of tokens of French origin.

Pronunciation Guessing 420 generates pronunciations for one or more Token Lists 415. These pronunciations are generated via statistical G2P models 325. The models used to generate the pronunciation for a given token are activated by Weights 425A, 425B and 425C, which are collectively referred to as Weights 425. For example, if Weight 425A is set to 1.0, and all other weights are set to 0.0, only G2P Model 325A would be used to generate one or several pronunciations. If for example Weight 425A is set to 0.5 and Weight 425B is set to 0.5, and all other weights are set to 0.0, the respective G2P Models 325A and 325B would be interpolated, e.g., linearly or log-linearly, with the respective weights. Thus, the effect of the various G2P Models 325 on the resulting pronunciation can be controlled. The weights may depend on meta data which might be part of Token Lists 415. For example, this meta data may indicate that the tokens in Token List 415B are of French origin. If G2P Model 325B has been trained on French token/pron pairs, where the pronunciations are informed, we may set the Weight 425B to 1.0, and all other weights to 0.0 within module Pronunciation Guessing 420, so that the resulting pronunciations reflect informed pronunciation style. If we want to reflect a pronunciation style closer to the native language of the speaker, which may be English, we may set the Weight 425A to 0.5 and Weight 425B to 0.5, assuming G2P Model 325A has been trained on English token/pron pairs and thus representing how native speakers of English speak. The resulting pronunciations are paired with the respective tokens from Token Lists 415 thus rendering Foreign Named Entity Dictionaries 435. In general, meta data might be any use-case dependent information on which kind of pronunciations, e.g. naive, informed, or in-between, we might want to generate for each of the Token Lists 415. Meta data might also be manually devised and accompany Token Lists 415.

As an example, we might wish to build an ASR system that is able to recognize commands including native and foreign named entities for a navigational device in an automobile, as in “Find a fast route to Rue des Jardins in Paris” for a British English user base. The pronunciation of “Rue des Jardins” of a specific user 103 might depend on his or her knowledge of the foreign language, in our example, French. If the user has only little knowledge, he might pronounce the foreign named entity in a naive way as if it would be an English-named entity. If the user is fluent in the foreign language, he might pronounce it in an informed way like a native of the foreign language. Any knowledge level in between is also imaginable.

To support naive, informed, and in-between pronunciation variants, we first prepare Recognition Dictionaries 230, via building G2P Models 325. To do so, we assume having access to sufficient token/pron pairs of English words, and French words, for the pronunciations of which the English phoneme set is used, at least for the sake of this example. We assume both are available in Pronunciation Dictionary Database 145. Note that Pronunciation Dictionary Database 145 does not necessarily need to contain foreign named entities. Data Partitioning/Selection 310 may now be configured in a way to separate English token/pron pairs from French token/pron pairs, resulting in, for example, G2P Training Dictionary 315A containing all English token/pron pairs and Training Dictionary 315B containing all French token/pron pairs. G2P Model Training 320 may generate (a) a statistical model based on Training Dictionary 315A covering English token/pron pairs, referred to as G2P Model 325A, and (b) a statistical model based on Training Dictionary 315B covering French token/pron pairs, referred to as G2P Model 325B. Note that there may be more G2P Training Dictionaries 315 and thus G2P models 325 for other languages, but they are not considered in this example.

G2P Models 325A and 325B may now be used within Pronunciation Generation 330. Assume Token Database 150 contains the multi-word token “Rue des Jardins”. Partition/Selection 405 may now separate all French tokens, possibly due to meta data also available in Token Database 150, into Token List 415A. Pronunciation Guessing 420 might now, for example, generate three prons for “Rue des Jardins”, depending on Weights 425. For a naive pronunciation, we may set Weight 425A to 1.0 and all other weights to 0.0. Thus, we would only use G2P Model 325A to generate a pronunciation. As noted above, G2P Model 325A has been trained on English token/pron pairs only, and the prons generated with this model reflect English pronunciation. For an informed pronunciation, we may set Weight 425B to 1.0 and all other weights to 0.0. As noted above, G2P Model 325B has been trained on French token/pron pairs only, and the prons generated with this model reflect French pronunciation. For an in-between pronunciation, we may, for example, set both Weight 425A and Weight 425B to 0.5, and all other weights to 0.0. In this way, the scores of both G2P Models 325A and 325B may be interpolated (either for example, linearly or log-linearly, or combined in any other fashion) to output an in-between pronunciation. Note that we could as well generate more than one pronunciation per token for any Weights 425.

Foreign Named Entity Dictionary 435A would now contain French tokens with naive, informed, and in-between pronunciations.

We may assume that Foreign Named Entity Dictionary 435A is incorporated into Recognition Dictionary 230B. We may further assume that Recognition Dictionary 230A contains English token/pron pairs.

Recognition Dictionaries 230A and 230B may be used in ASR Engine 215. When User 101 utters the phrase “Find a fast route to Rue des Jardins in Paris” as Speech Input 205, we may assume that we have GPS coordinates indicating that the automobile is located in France. These GPS coordinates may be part of Meta Data 210 and could possibly be used to trigger Weights 225A and Weights 225B to be set to 1, indicating that both, the English Recognition Dictionary 230A and the French Recognition Dictionary 230B should be active while running ASR. Since Recognition Dictionary 230B contains naive, informed, and in-between pronunciation variants of “Rue des Jardins”, there is a higher possibility that the system will output Text 240 correctly, compared to only relying on Recognition Dictionary 230A.

Thus, system 100 leverages naive and informed models to automatically generate pronunciations for foreign named entities, and combines the models via interpolation into one model to generate pronunciations that are tailored to the knowledge of foreign language of the user. Such a system will better match the utterances and improve overall ASR accuracy. By tuning the interpolation weight between the models per speaker, system 100 can smoothly move between recognizing “informed”, “naive” and “naive in-between” speakers. This method is also not constrained to only two models, or any particular kind of model (e.g., classical n-gram, Recurrent Neural Network (RNN), Long Short-Term Memory (LSTM), . . . ).

Since system 100 employs separate models for separate languages, it can even tailor the type of pronunciation modelling to a given speaker per language. This might be useful, for example, for a case of a speaker who is fluent in French, but their knowledge of English is limited.

The techniques described herein are exemplary and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. An automated speech recognition (ASR) system, comprising:
a microphone;
a recognition dictionary storage that contains:
(a) a first recognition dictionary that stores a first pronunciation of a token that was generated from a first grapheme-to-phoneme model (G2P) for said token; and
(b) a second recognition dictionary that stores a second interpretation of said token that was generated from a second G2P model for said token;
a G2P weight storage that contains:
(a) a first G2P weight that is applicable to said first G2P model to yield said first pronunciation for said token; and
(b) a second G2P weight that is applicable to said second G2P model to yield said second pronunciation for said token;
a processor that receives an utterance containing a spoken form of said token from said microphone; and
a memory that contains instructions that are readable by said processor to control said processor to:
obtain metadata concerning said token;
modify said first G2P weight and said second G2P weight based on said metadata, thus yielding a first weighted G2P model and a second weighted G2P model;
interpolate said first weighted G2P model and said second weighted G2P model to yield a resultant pronunciation for said token; and
provide an output based on said resultant pronunciation.

2. The ASR system of claim 1,
wherein said utterance is spoken by a user, and
wherein said metadata identifies a characteristic of said user.

3. The ASR system of claim 2, wherein said characteristic of said user is a native language of said user.

4. The ASR system of claim 1, further comprising:
a user device; and
a global positioning system that identifies a present location of said user device,
wherein said metadata comprises said present location.

5. The ASR system of claim 1, wherein said output comprises a signal to control a device.
